(19) United States
(12) Patent Application Publication
(10) Pub. No.: US 2014/0097380 A1
(43) Pub. Date: Apr. 10, 2014

(54) Aligned Graphene Sheets-Polymer Composite and Method for Manufacturing the Same

(71) Applicant: TAIWAN TEXTILE RESEARCH INSTITUTE, New Taipei City (TW)

(72) Inventors: Ting-Yu Wu, New Taipei City (TW); Jui-Chi Lin, New Taipei City (TW); Tai-Hong Cheng, New Taipei City (TW); Shiao-Yen Lee, New Taipei City (TW); Min-Chi Tsai, New Taipei City (TW); Jen-Chun Yu, New Taipei City (TW); Shinn-Shyong Tzeng, New Taipei City (TW); Yu-Hong Lin, New Taipei City (TW)

(73) Assignee: TAIWAN TEXTILE RESEARCH INSTITUTE, New Taipei City (TW)

(21) Appl. No.: 13/832,493

(22) Filed: Mar. 15, 2013

(30) Foreign Application Priority Data
Oct. 9, 2012 (TW) 101137305

(51) Int. Cl. C09K 5/14

(52) U.S. Cl. CPC C09K 5/14
USPC 252/74; 264/437

(57) ABSTRACT

A method for fabricating an aligned graphene sheet-polymer composite is provided, which includes the steps below. A mixture is prepared with the dispersed graphene sheets in the polymer fluid. The graphene filament bundles substantially paralleled to each other are formed by a sequence of aligned graphene sheets in the polymer fluids when a field was applied. Finally, the mixture is solidified. An anisotropic index in a range of 1.00 to 2.00 is obtained in an aligned graphene sheet-polymer composite by calculating the ratio of the coefficient of thermal conductivity in a parallel direction and the one in perpendicular direction. The aligned graphene sheet-polymer composite is also provided.

### RELATED APPLICATIONS

This application claims priority to Taiwanese Application Serial Numbers 101137305, filed Oct. 9, 2012, which is herein incorporated by reference.

### BACKGROUND

1. Technical Field

The present disclosure relates to an aligned graphene sheets-polymer composite and a method for manufacturing the aligned graphene sheets-polymer composite.

2. Description of Related Art

A graphene sheet, originated from a graphite structure, is a rising star of carbon nanomaterial following the carbon nanotube in this decade. With an ultrahigh electron mobility (15000 cm²/v.s) and thermal conductivity (5300 W/mK), a strong mechanical properties and a large specific area, graphene sheet has been employed in several applications, such as transparent conductor, super capacitor or Li secondary battery. In a point view for the composite, graphene sheet also are considered as a suitable additive to improve the electrical or thermal conductive properties.

However, it is still difficult to apply the graphene sheets in practical due to their agglomeration or self-assembly.

Ali Raza et al. (“Characterization of graphite nanoplatelets and the physical properties of graphite nanoplatelet/silicone composites for thermal interface application,” Carbon (2011)) provided composites with various ratios of graphene sheets to silicone rubber. Only a 1.9 W/mK of thermal conductivity in grahene sheets/silicone rubber composites was achieved when the contents of graphene sheets were higher than 20 wt %. Due to the high price of the graphene sheets, how to significantly enhance the thermal conductivity with low amount of the graphene sheets is still an issue to be addressed in this field.

### SUMMARY

The present disclosure provides an aligned graphene sheet-polymer composite with an anisotropic behavior. An anisotropic index, defined by the ratio of thermal conductivity of an aligned graphene sheets-polymer composite in the direction parallel and perpendicular to the field direction, can be as high as 1.83 when the content of the graphene sheets is lower than 1.00 wt %. Compared with the blended graphene sheets-polymer composite, the thermal conductivity of the aligned graphene sheet-polymer composite is equal to or more than three times of that of the blended graphene sheet-polymer composite.

An embodiment of the present disclosure provides a method for manufacturing an aligned graphene sheets-polymer composite, which includes the steps below. Graphene sheets are dispersed in a polymer fluid to form a mixture. A field is applied to the mixture in an acting direction for the alignment of the graphene sheets to form graphene filament bundles substantially parallel to each other in the polymer fluid. The mixture is solidified to form the aligned graphene sheet-polymer composite. The aligned graphene sheet-polymer composite has an anisotropy index in a range of 1.00 to 2.00, which is the ratio of the thermal conductivity in a direction parallel to the field direction to the thermal conductivity in a direction vertical to the acting direction of the field.

Another embodiment of the present disclosure provides an aligned graphene sheets-polymer composite, which includes a polymer matrix and aligned graphene sheets. The aligned graphene sheets include graphene filament bundles disposed in the polymer matrix, and the graphene filament bundles are substantially parallel to each other.

### BRIEF DESCRIPTION OF THE DRAWINGS

The disclosure may be more fully understood by reading the following detailed description of the embodiments, with reference made to the accompanying drawings as follows:

FIG. 1 is a flow chart of a method for manufacturing an aligned graphene sheets-polymer composite according to one embodiment of the present disclosure;

FIGS. 2A, 2B and 2C respectively are a perspective view, a top view and a cross-sectional view of an aligned graphene sheets-polymer composite according to one embodiment of the present disclosure;

FIGS. 3A, 3B and 3C respectively are a perspective view, a top view and a cross-sectional view of an aligned graphene sheets-polymer composite according to another embodiment of the present disclosure;

FIGS. 4A, 4B and 4C respectively are a perspective view, a top view and a cross-sectional view of an aligned graphene sheets-polymer composite according to a further embodiment of the present disclosure;

FIG. 5 is a top view optical microscopy (OM) image of an aligned graphene sheets-polymer composite according to one embodiment of the present disclosure;

FIG. 6 is a top view OM image of the aligned graphene sheets-polymer composite of Comparative Example 1;

FIG. 7 is a top view OM image of the aligned graphene sheets-polymer composite of Comparative Example 2;

FIG. 8 is a top view OM image of the aligned graphene sheets-polymer composite of Comparative Example 3;

FIG. 9 is a cross-sectional view OM image of the aligned graphene sheets-polymer composite of Example 2;

FIGS. 10A-10B respectively are a top view OM image and a cross-sectional view OM image of the aligned graphene sheets-polymer composite of Example 5;

FIGS. 11A-11B respectively are a top view OM image and a cross-sectional view OM image of the aligned graphene sheets-polymer composite of Example 6;

FIG. 12 is a cross-sectional view OM image of the aligned graphene sheets-polymer composite of Example 7;

FIGS. 13A-13B respectively are a top view OM image and a cross-sectional view OM image of the aligned graphene sheets-polymer composite of Example 8;

FIG. 14 is a cross-sectional view OM image of the aligned graphene sheets-polymer composite of Example 10;

FIG. 15 is a cross-sectional view OM image of the aligned graphene sheets-polymer composite of Example 11;

FIG. 16 is a cross-sectional view OM image of the aligned graphene sheets-polymer composite of Example 12;

FIG. 17 is a relationship diagram of the anisotropy index, the content of the graphene sheets and the electric field of Examples 1 to 12; and

FIG. 18 is a relationship diagram of the alignment index, the content of the graphene sheets and the electric field of Examples 1 to 12.

### DETAILED DESCRIPTION

The present disclosure is described by the following specific embodiments. Those with ordinary skill in the arts can readily understand the other advantages and functions of the present disclosure after reading the disclosure of this specification. The present disclosure can also be implemented with different embodiments. Various details described in this specification can be modified based on different viewpoints and applications without departing from the scope of the present disclosure.

As used herein, the singular forms “a,” “an” and “the” include plural referents unless the context clearly dictates otherwise. Therefore, reference to, for example, a data sequence includes aspects having two or more such sequences, unless the context clearly indicates otherwise.

Reference will now be made in detail to the embodiments of the present disclosure, examples of which are illustrated in the accompanying drawings. Wherever possible, the same reference numbers are used in the drawings and the description to refer to the same or like parts.

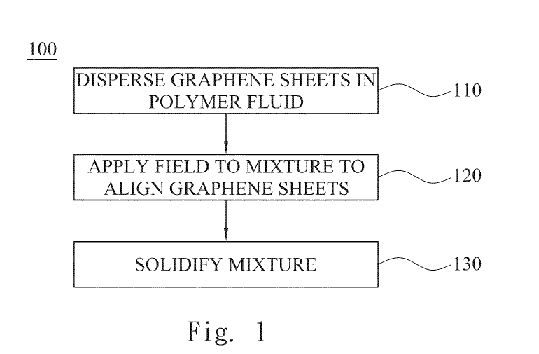

FIG. 1 is a flow chart of a method 100 for manufacturing an aligned graphene sheet-polymer composite, which includes dispersing graphene sheets in a polymer fluid (step 110), applying a field to the mixture to align the graphene sheets (step 120) and solidifying the mixture (step 130).

The aligned graphene sheets-polymer composites manufactured by employing the method of the present disclosure with an anisotropy index (the term “anisotropy index” refers to the ratio of the thermal conductivity in a direction parallel to the field direction to that in a direction vertical to the field direction) in a range of 1.00 to 2.00 were able to be used as electromagnetic interference (EMI) shielding materials, thermal conductive graphite flakes, thermal interface materials or impact absorption pads.

In addition, the aligned graphene sheets-polymer composite can be applied in the textile field. For instance, the composite is coated on the surface of fiber or yarn to enhance conductive, thermal conductive, mechanical and anti-wear properties thereof.

In step 110, a mixture is formed by dispersing the graphene sheets in a polymer fluid. For example, the graphene powder and the polymer fluid are uniformly mixed by mechanical stirring. In one embodiment, the polymer fluid has a room temperature-hardening characteristic, such that a space-fabric like structure (i.e., the aligned graphene structures) formed in step 120 would not be seriously damaged during solidifying step (i.e., step 130). Therefore, the graphene sheets of the embodiment with an excellent thermal conductivity are enable to enhance the thermal conductivity for the aligned graphene sheets-polymer composites. Based on the above, the polymer fluid is selected from the group consisting of silicone rubber, nature rubber, polyurethane and a combination thereof. For an example, the polymer fluid is silicone rubber, which is a two-liquid reaction type vulcanizing silicone (RTVII). In one embodiment, the polymer fluid with a viscosity in a range of 2,500 to 3,500 cps at 25° C. could facilitate the rotation or movement of the graphene sheets which is favorable of the alignment thereof (step 120).

The graphene sheets are a three-dimensional stacked platelet-like nanostructure composed of graphene layers. The graphene layer is a two-dimensional nano-carbon molecular structure constituted by a hexagonal carbon ring molecular structure extending along the (001) crystal plane. The adjacent graphene layers in a specific stacking sequence are stacked to each other by Van der Waals attraction and the aforementioned three-dimensional stacked platelet-like nanostructure are formed. The type of the stacking structure of graphene layers is identified by their stacking sequence which includes a disordered structure with AA stacking sequence, a hexagonal structure with AB stacking sequence and a rhomboidal structure with ABC stacking sequence.

In one embodiment, the width of basal plane in graphene sheets is generally in a range of 0.1 to 300 μm, better in a range of 1 to 50 μm. The width of basal plane in graphene sheets mainly refers to the width of graphene sheet in a microscopic view, or the D50 particle size of the graphene powders in a macroscopic view.

In one embodiment, the thickness of the graphene sheets is in a range of 0.1 to 10,000 nm, better in a range of 100 to 1,000 nm. The thickness refers to a total thickness of the stacked graphene layers.

In one embodiment, the graphene sheets have an aspect ratio in a range of 0.01 to 3,000,000. The aspect ratio refers to a ratio of the width of the basal plane to the thickness of the graphene sheets.

In one embodiment, the graphene sheets with a content of 0.01 to 1.00 wt % was used, better from 0.25 to 0.75 wt %. The content of the graphene sheets must be as low as possible to reduce the material cost.

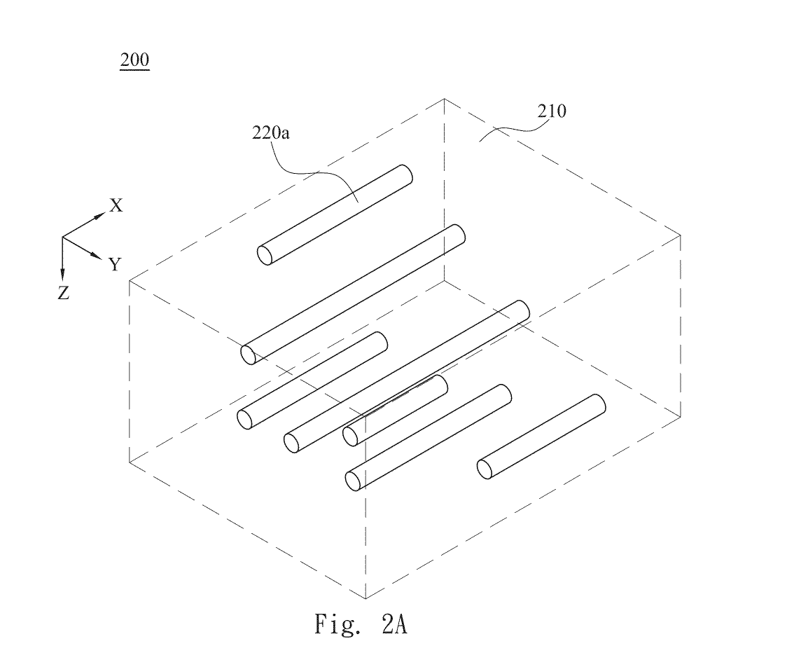

In step 120, a graphene filament bundles 220a substantially parallel to each other in polymer fluid was comprised of a series of aligned graphene sheets when a external field is applied, as shown in FIG. 2A. In one embodiment, the graphene filament bundles 220a are substantially parallel to the field direction (i.e., X direction); that is, the alignment of the grapehene sheets was driven by an external force generated by the applied field (e.g., electric field). The external force would not only leads to a polarization of the dispersed graphene sheets, but provide a driving force for the graphene sheets to overcome gravity, polymer viscosity and steric hindrance, also further induced a rotation or movement for the graphene sheets, and finally the aligned graphene filament bundles 220a are formed rather than only aggregated graphite blocks.

In one embodiment, the field is an electric field, a magnetic field, a mechanical field or an electromagnetic field. In one embodiment, step 120 is applying an electric field to the polymer fluid mixture, and the electric field strength is in a range of 1 to 5 kV/cm. For instance, the aforementioned polymer fluid mixture is poured into a mold, and the electric field with a certain direction is then applied to the polymer fluid mixture.

Next, in step 130, a composite is solidified from the polymer fluid mixture including a polymer matrix 210 and aligned graphene sheets. In this step, the solidifying reaction of the polymer is preferably performed at ambient temperature to avoid the disintegration of the graphene filament bundles 220a due to the thermal fluctuation of polymer chains in high temperature reaction.

Since the thermal conductivity of aligned graphene sheets-polymer composites and their anisotropic index would be affect by the arrangement of the graphene sheets, the inventors have provided a method for the calculation of the alignment index considering the effects of the polymer viscosity, the content of the graphene sheets and the electric field to the arrangement of the graphene sheets. The alignment index is calculated according the formula below: alignment index=content of graphene sheets (wt %)×electric field strength (kV/cm)×(anisotropy index)×1,000/viscosity of the polymer fluid (cps). In one embodiment, the alignment index of graphene sheets-polymer composites is in a range of 0.01 to 1.30.

Further, in step 120, not only the graphene filament bundles 220a but a newly three-dimensional microstructure is also found, called space-fabric like structure, which is comprised of a series of graphene filament bundles 220a aligned along with the field direction and a few of interconnected graphene filaments 220b. The detailed information of the microstructural transformation is described below.

As shown in FIGS. 2A-2C, only a series of graphene filament bundles 220a substantially parallel to each other are mainly aligned along with the external field direction in the polymer matrix 210. Neither obvious internal connection between the aligned graphene filament bundles 220a nor the space-fabric like structure were observed in the polymer matrix 210. In one embodiment, the graphene filament bundles 220a with a diameter D in a range of 1 to 20 μm are shown in FIG. 2C.

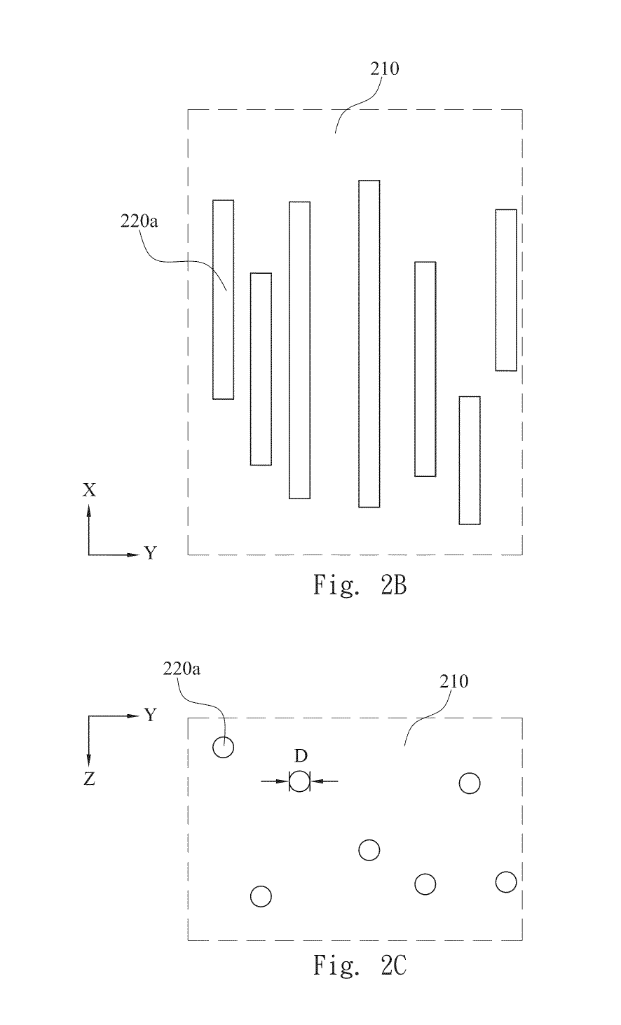

As shown in FIGS. 3A-3C, a space-fabric like structure is comprised of the graphene filament bundles 220a and the interconnected graphene filaments 220b in the polymer matrix 210. The interconnected graphene filaments 220b is interconnected to at least two graphene filament bundles 220a, and the interconnection would enhance the thermal conductivity of the composites.

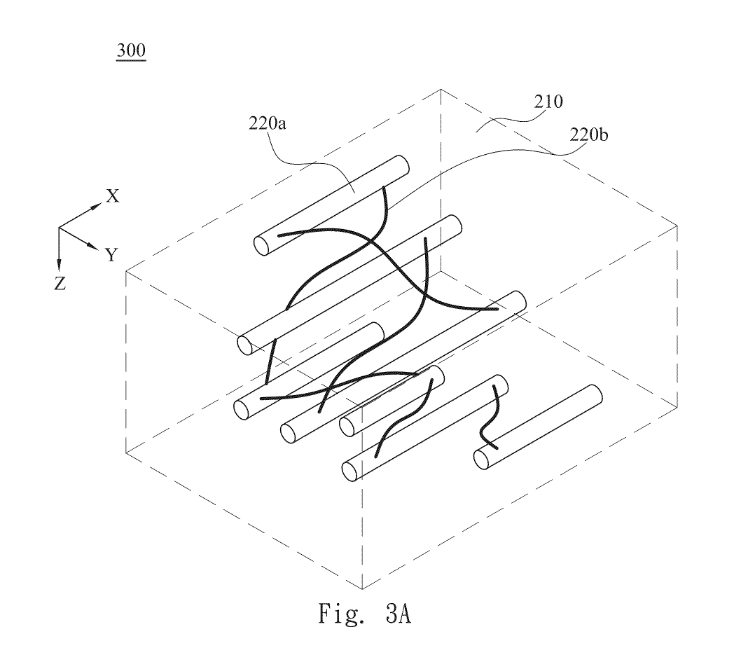

As shown in FIGS. 4A-4C, a space-fabric like structure is comprised of the aligned graphene rod bundles 220c and the interconnected graphene filaments 220b in the polymer matrix 210. The aligned graphene rod bundles 220c are composed of many graphene filament bundles 220a contacted to each other. In one embodiment, a maximum width (Wmax) of the aligned graphene rod bundles 220c is more than or equal to 50 μm, as shown in FIG. 4C.

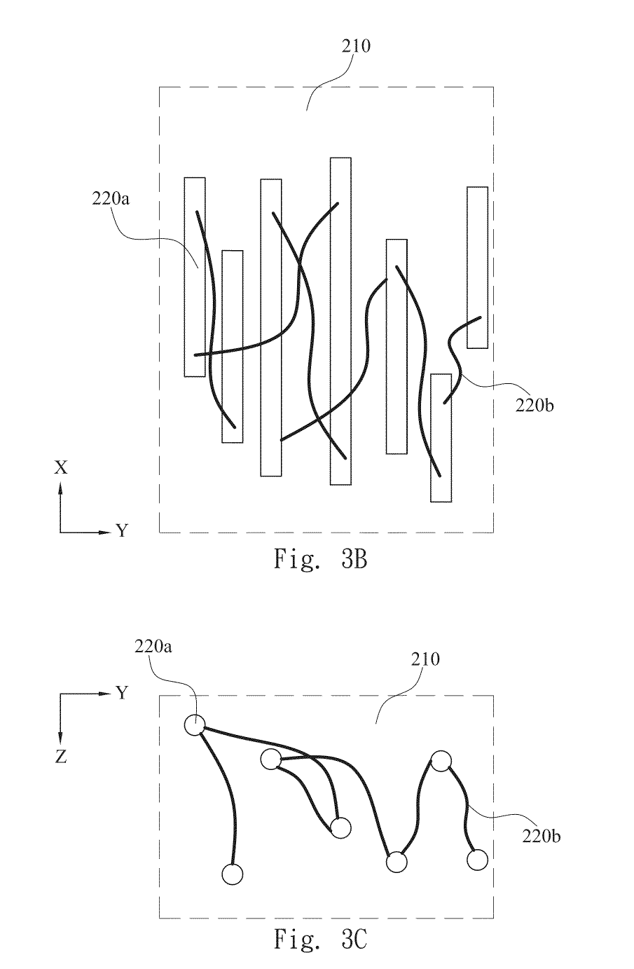

In those examples hereinafter, the inventors have found that the enhancement on the anisotropy of aligned graphene sheets/polymer composites is related to the formation of space-fabric like structure, which is comprised of the graphene filament bundles 220a and the interconnected graphene filaments 220b, while the anisotropic index is higher (in a range of 1.30 to 2.00), as shown in FIG. 5. The highly anisotropic composite could be applied in the application of anisotropic electrical/thermal conductive materials or impact absorption materials.

As mentioned above, the embodiments of the present disclosure provides the aligned graphene sheets-polymer composite with low contents of the graphene sheets and a method for manufacturing the same. The anisotropy index of the composite can be as high as 1.83 and able to be used as EMI shielding materials, thermal conductive graphite flakes, thermal interface materials, anisotropic electrical/thermal conductive materials or impact absorption materials.

### EXAMPLES

The following Examples are provided to illustrate certain aspects of the present disclosure and to aid those of skill in the art in practicing this disclosure. These Examples are in no way to be considered to limit the scope of the disclosure in any manner.

### Comparative Examples 1-5

### Blended Graphene Sheets/Silicone Rubber Composites

The manufacturing process of Comparative Examples 1-5 includes the steps below. First, a mixture of graphene sheets/silicone fluid was prepared by by mechanical stirring, and then poured into a mold. After a solidification of 24 hours, blended graphene sheets/silicone rubber composites were prepared. Table 1 shows the thermal conductivity of graphene sheets/silicone rubber composites and their processing parameters.

TABLE 1

| | Silicone | | Graphene | |
|---|---|---|---|---|
| | Weight | Vis- | sheets | Thermal |
| | ratio | cosity | Weight ratio | conductivity |
| | (wt %) | (cps) | (wt %) | (W/mK) |
| Comparative Example 1 | 100 | 2500 | 0.1 | 0.11 |
| Comparative Example 2 | 99.5 | 3000 | 0.5 | 0.20 |
| Comparative Example 3 | 99 | 4000 | 1 | 0.21 |
| Comparative Example 4 | 98 | 6500 | 2 | 0.23 |
| Comparative Example 5 | 95 | 15000 | 5 | 0.30 |

As shown in Table 1, only a slightly increase in thermal conductivity from 0.11 to 0.30 W/mK was observed when the graphene sheets contents raised from 0.1 to 5 wt %.

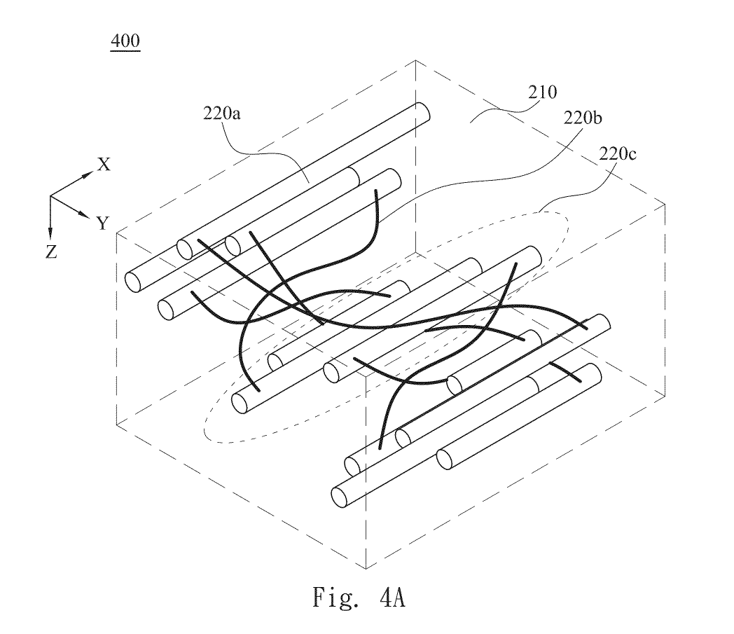

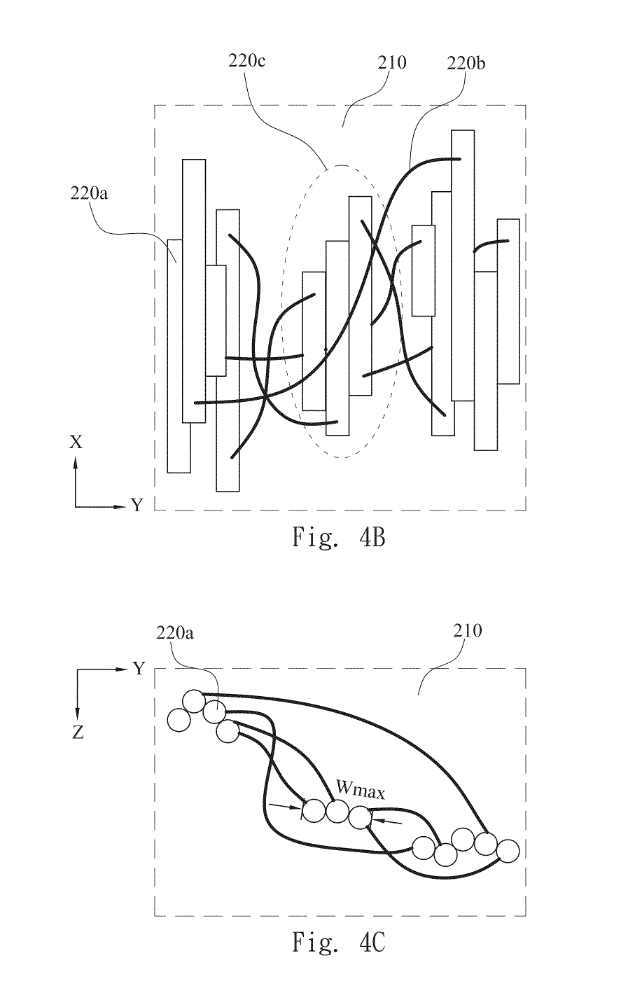

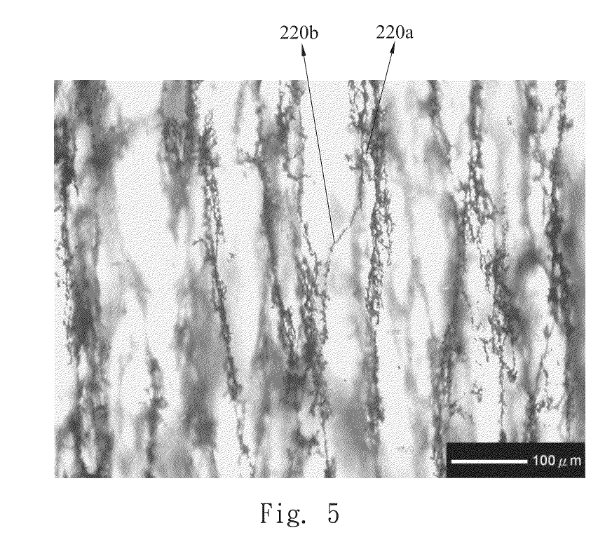

FIGS. 6, 7, and 8 shows the top view optical microscope (OM) images of Comparative Example 1, Comparative Example 2 and Comparative Example 3 respectively. As shown in FIG. 6 and FIG. 7, the graphene sheets with well-dispersion in the silicone rubber matrix was observed. No obvious continuous agglomeration leads to separated phase and further resulted in a lower performance in thermal conductivity for Comparative Examples 1 to 4. Finally, a slightly agglomeration was observed when the content of the graphene sheets is 1 wt %, as shown in FIG. 8.

### Comparative Example 6-7

### Carbon Nanotube/Silicone Rubber Composites

The manufacturing process of Comparative Example 6 includes the steps below. First, a mixture of carbon nanotubes/silicone fluid was prepared by mechanical stirring with carbon nanotubes content of 0.5 wt %, and then poured in a mold with a parallel carbon electrode. An electric field strength of 3 kV/cm generated by direct current method is applied to the carbon nanotubes/silicone fluid mixture during the solidification of silicone fluid. After a solidification for 24 hrs, the aligned carbon nanotubes/silicone rubber composite was obtained. For the comparison, a blended carbon nanotubes/silicone rubber composite was prepared without alignment, called Comparative Example 7. Table 2 lists the thermal conductivity of aligned carbon nanotubes/silicone rubber composites measured from the different direction, which is the direction parallel to the field direction (X direction) and the direction perpendicular to the field direction (Z direction). The term “anisotropy index” herein refers to the ratio of the thermal conductivity in X direction (i.e., field direction) to the thermal conductivity in Z direction (i.e., thickness direction).

TABLE 2

| | | | Carbon | | | | | |
|---|---|---|---|---|---|---|---|---|
| | Silicone | | nanotube | Electric | Thermal conductivity | | | |
| | Weight | | Weight | field | (W/mK) | | | |
| | ratio | Viscosity | ratio | strength | X | Z | Anisotropy | Alignment |
| | (wt %) | (cps) | (wt %) | (kV/cm) | direction | direction | index | index |
| Comparative | 99.5 | 3000 | 0.5 | 3 | 0.56 | 0.53 | 1.06 | 0.53 |
| Example 6 | | | | | | | | |
| Comparative | 97 | >50000 | 3 | 0 | 0.27 | — | — | — |
| Example 7 | | | | | | | | |

As shown in Comparative Example 2 and Comparative Example 6, the thermal conductivity of aligned carbon nanotubes/silicone rubber composite in both X and Z direction is around 0.5 W/mK, which is slightly higher than that of Comparative Example 7. It is because that the external electric filed would enhance the formation of continuous phase of carbon nanotubes in silicone rubber matrix. For the calculation of anisotropic index of Comparative Example 6, only 1.06 in anisotropic index for the Comparative Example 6 means an obvious isotropic behavior was observed in the aligned carbon nanotubes/silicone rubber composites.

### Examples 1 to 12

### Aligned Graphene Sheets/Silicone Rubber Composites

The manufacturing process of Examples 1 to 12 includes the steps below. First, a mixture of graphene sheets/silicone fluid was prepared by mechanical stirring with different graphene contents, and then poured in a mold with a parallel carbon electrode. Next, an electric field with different electrical field strength was applied to the graphene sheets/silicone fluid during the solidification of silicone fluid. After a solidification for 24 hrs, the aligned carbon nanotubes/silicone rubber composite was obtained. Table 3 lists the thermal conductivity of aligned graphene sheets/silicone rubber composites measured from the different direction, which is the direction parallel to the field direction (X direction) and the direction perpendicular to the field direction (Z direction).

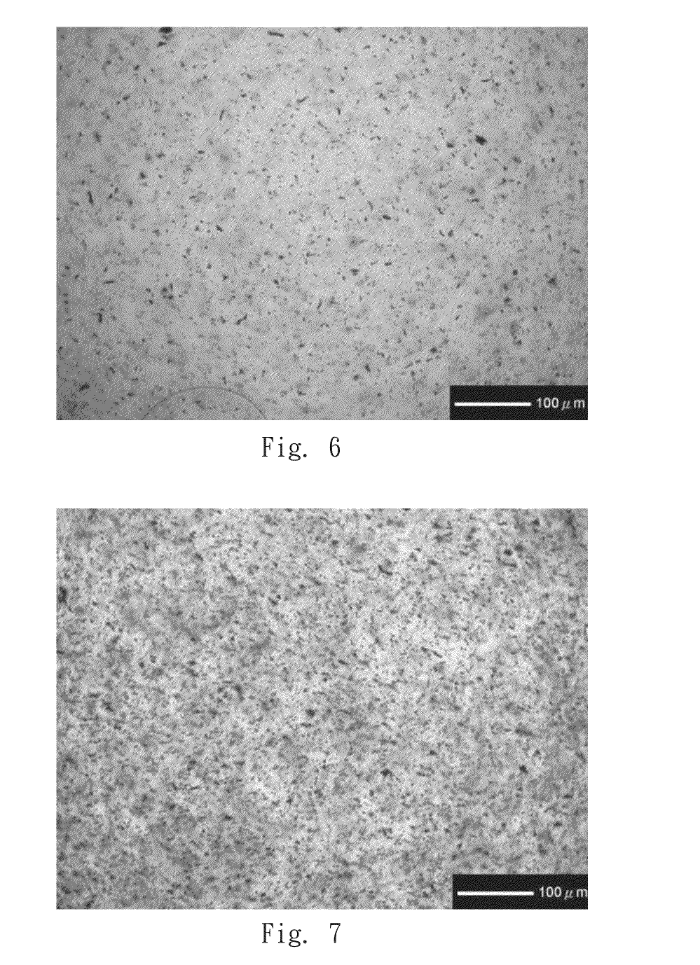

The anisotropy indexes of Examples 1 to 4 are in a range of 1.02 to 1.11 when the electric field strength is 2 kV/cm. The thermal conductivities of Examples 1 to 4 in X direction (i.e., along with the field direction) are in a range of 0.33 to 0.46 W/mK, and the thermal conductivities thereof in Z direction (i.e., vertical to the field direction) are in a range of 0.30 to 0.43 W/mK. FIG. 9 is a cross-sectional OM image of the graphene sheets-silicone composite of Example 2.

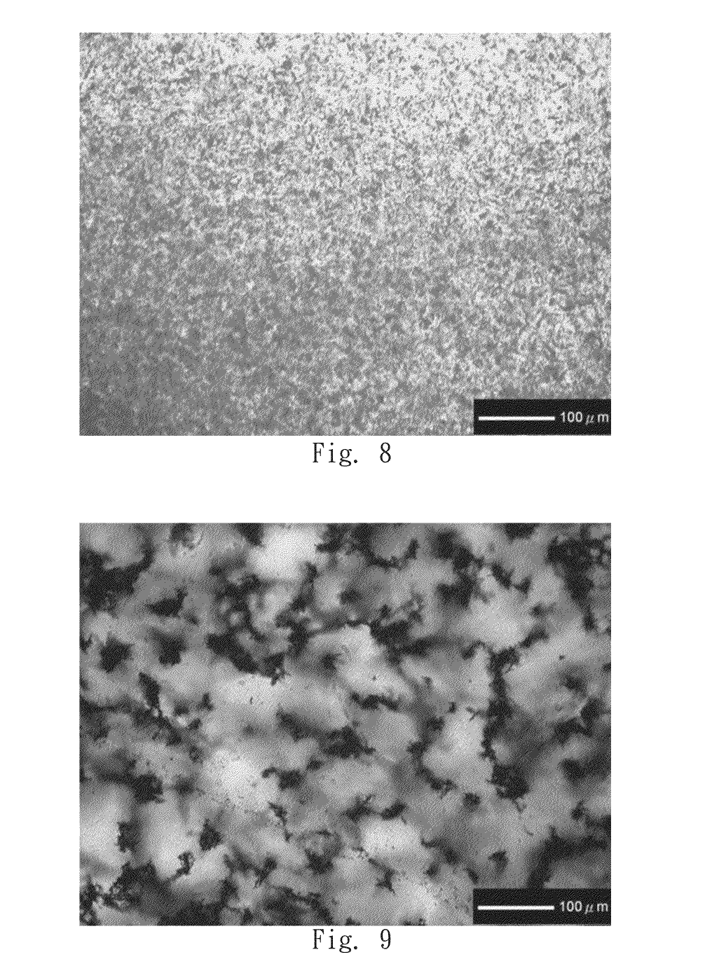

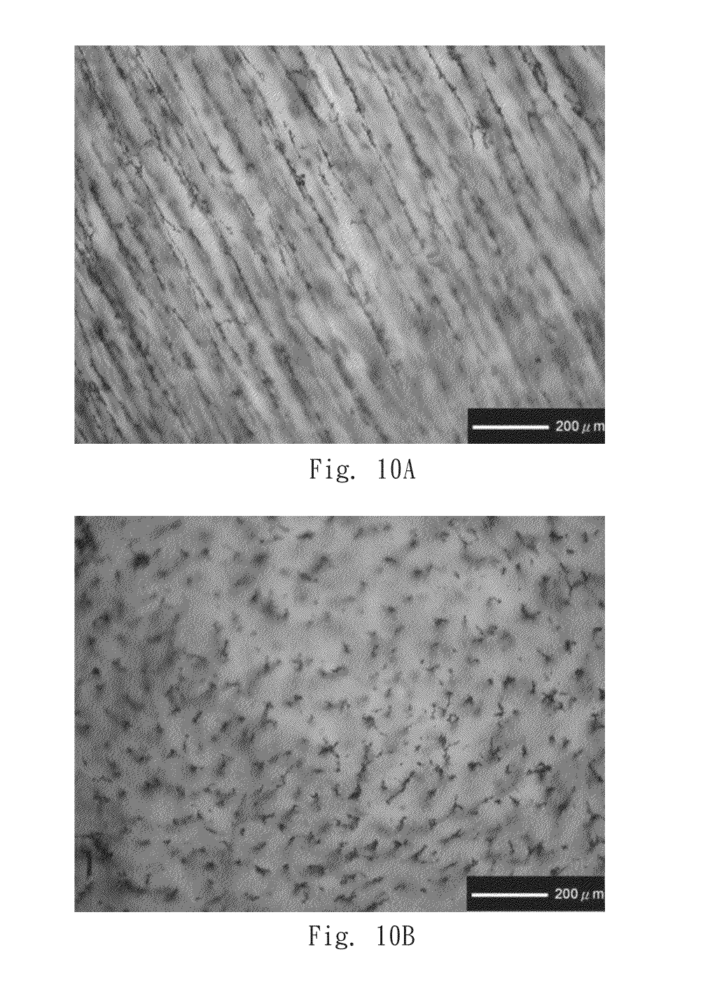

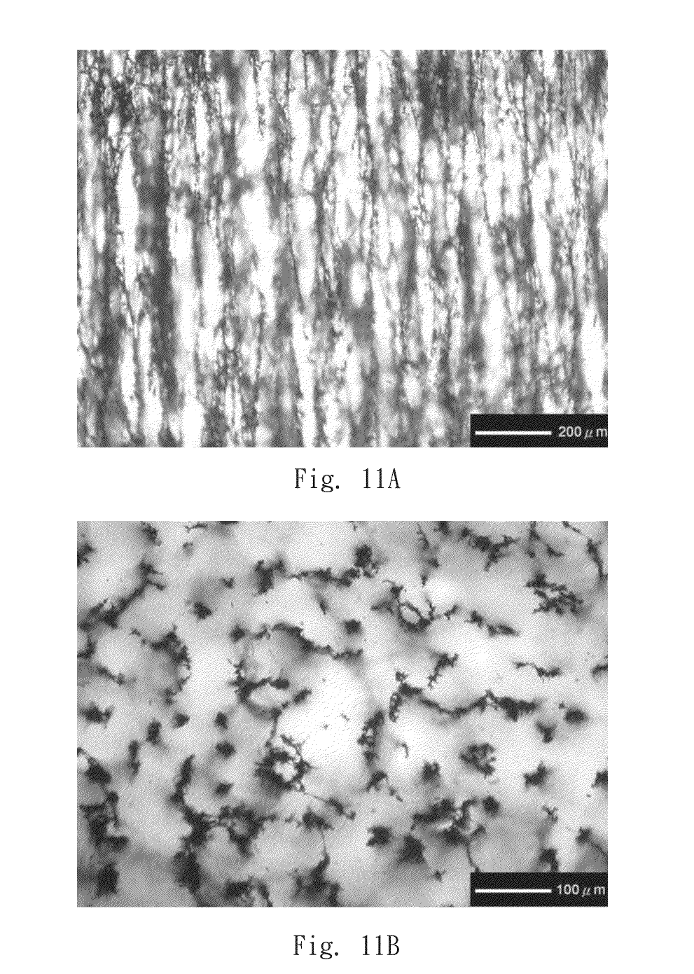

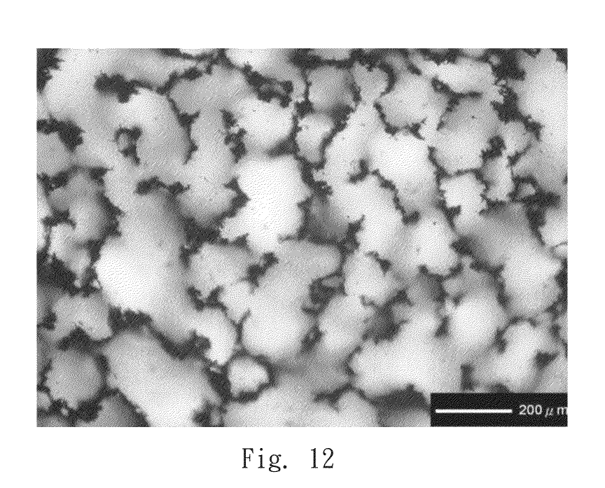

The anisotropic indexes of Examples 5 to 8 are in a range of 1.14 to 1.83 when the electric field strength is 3 kV/cm. A relative higher anisotropic index of 1.83 and 1.48 was found in Examples 6 and 7. The thermal conductivities of Examples 5 to 8 in X direction are in a range of 0.57 W/mK to 0.77 W/mK, and the thermal conductivities thereof in Z direction are in a range of 0.42 W/mK to 0.54 W/mK. FIGS. 10A (top view) and 10B (cross-sectional view), FIGS. 11A (top view) and 11B (cross-sectional view), FIG. 12 (cross-sectional view) and FIGS. 13A (top view) and 13B (cross-sectional view) respectively shows the OM images of the graphene sheets/silicone rubber composites of Examples 5 to 8.

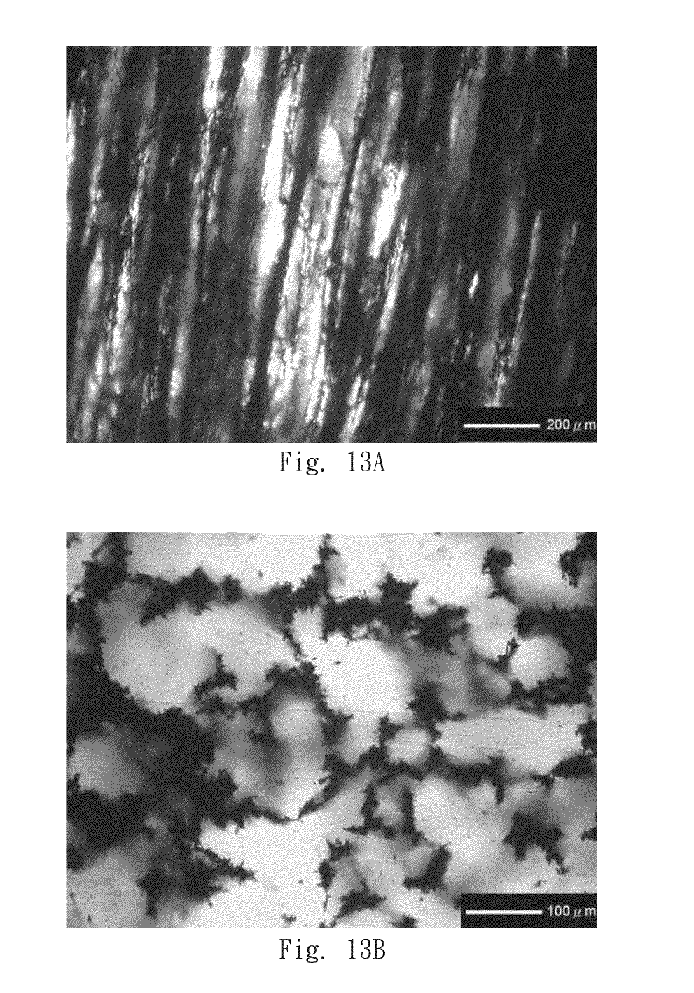

The anisotropy indexes of Examples 9 to 12 are in a range of 1.08 to 1.39 when the electrical field strength is 4 kV/cm. The thermal conductivities of Examples 9 to 12 in X direction are in a range of 0.31 to 0.52 W/mK, and the thermal conductivities thereof in Z direction are in a range of 0.28 to 0.39 W/mK. FIGS. 14, 15 and 16 shows the cross-sectional view OM images of the graphene sheets-silicone composites of Examples 10 to 12.

As mentioned above, in the embodiments, the preferable electric field strength is 3 kV/cm. In other words, the arrangement of graphene sheets in silicone fluid would be affected by the electric field strength, and further alter the anisotropic index and alignment direction of graphene sheets/silicone rubber composites. The graphene microstructures of Examples 5-8 and Examples 10-12 are described below.

FIG. 10A shows OM images of Example 5 in the top of view. As shown in FIG. 10A, only the aligned graphene filament bundles substantially parallel to each other in the silicone rubber composites are clearly observed. FIG. 10B indicates a cross section OM image of Example 5. As shown in FIG. 10B, the graphene filament bundles are uniformly dispersed in the silicone matrix. The thermal conductivities of Example 5 in X and Z directions are 0.57 W/mK and 0.50 W/mK, and the anisotropy index of Example 5 is 1.14.

FIG. 11A represents the OM image of Example 6 in a top view. As shown in FIG. 11A, a large amount of graphene filament bundles parallel to each other was observed. In addition, a few of interconnected graphene filaments between the graphene filament bundles were also found, which is also confirmed in FIG. 11B. Compared with the FIGS. 11A and 11B, a space-fabric like structure was formed in silicone rubber matrix, which is comprised of a series of graphene filament bundles and well interconnected graphene filaments. The thermal conductivities of Example 6 in X and Z directions are 0.77 and 0.42 W/mK, and the anisotropy index of Example 6 is 1.83.

In addition, the difference between Comparative Example 6 and Example 6 is the structure characteristics (i.e., the carbon source). The carbon nanotubes are not able aligned effectively under an external field due to their entangled morphology. On the other hand, with a flat and platelet structure characteristics graphene sheets are easy to be polarized under an external field, and further be aligned along with the field direction in silicone rubber matrix. Hence, the anisotropy index of Example 6 is higher than that of Comparative Example 6.

The microstructure of Example 7 shown in FIG. 12 is similar to that of Example 6 shown in FIG. 11B. The space-fabric like structure formed by aligned graphene sheets is also observed in Example 7. The thermal conductivities of Example 7 in X and Z directions are 0.68 and 0.46 W/mK, and the anisotropy of Example 7 index is 1.48.

FIG. 13A shows the OM image of Example 8 in a top view. As shown in FIG. 13A, a great number of graphene rod bundles was observed in silicone rubber matrix. Also, an obvious interconnection between graphene rod bundles are found in FIG. 13B. The thermal conductivities of Example 8 in X and Z directions are 0.64 W/mK and 0.54 W/mK, and the anisotropic index of Example 8 index is 1.19. It is indicates that the graphene rod bundles are easily formed when using a relatively high graphene content of 1 wt %. Compared with FIG. 13A and FIG. 13B, although the space-fabric like structure could be still observed, the increased amount of interconnected graphene filaments leads to a reduction of anisotropic behavior of Example 8.

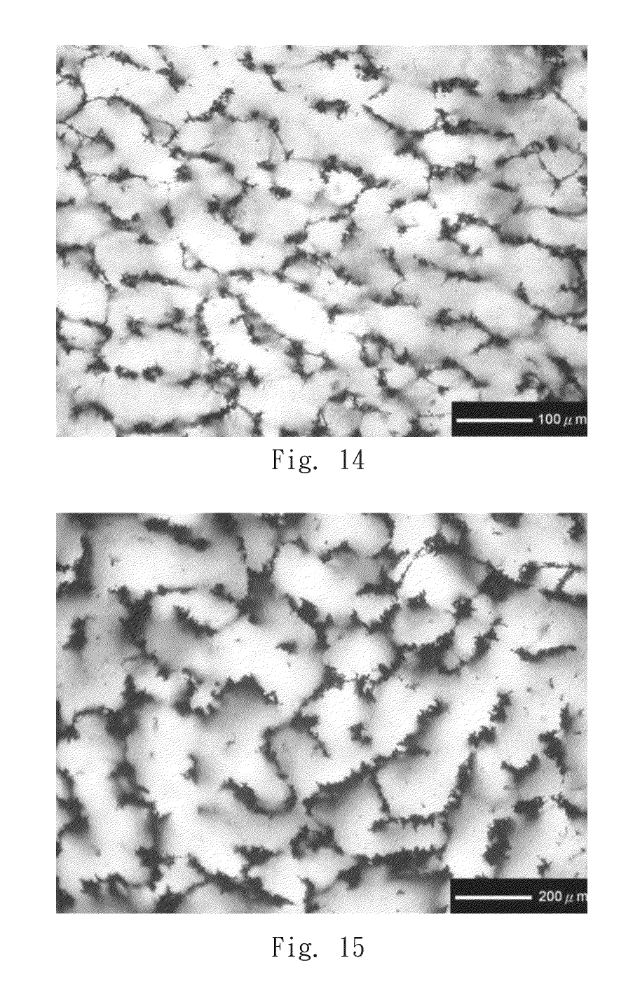

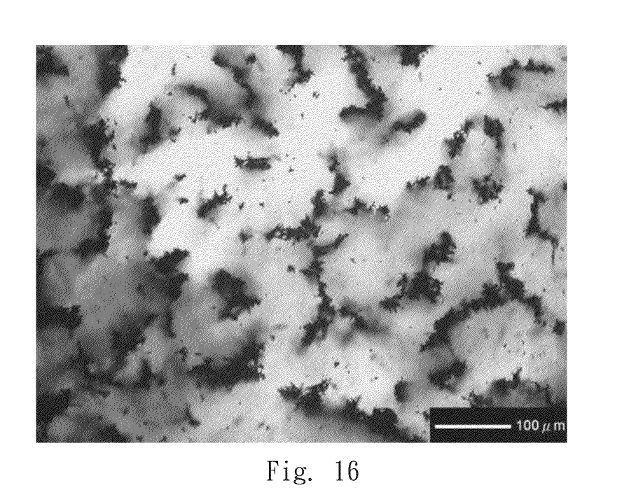

FIG. 14-16 shows the OM images of Example 10-12 from different side of view. As shown in FIGS. 14 to 16, the microstructural transformations are similar to those of Examples 6 to 8. An obvious increase in the amount of graphene filament bundles would be observed and also the amount of interconnected graphene filaments when the graphene content is from 0.5 wt % to 0.75 wt %, as shown in FIGS. 14 and 15. On the other hand, the amount of the graphene rod bundles would increase when the graphene content is from 0.75 wt % to 1.00 wt %, as shown in FIGS. 15 and 16.

Conclusively, the aligned graphene sheets/silicone rubber composite with a high anisotropic index is resulted by the formation of space-fabric like structure, which is comprised of aligned graphene filament bundles along with the direction of electric field and the interconnected graphene filaments. The anisotropic index could be considered as the structure characteristics of space-fabric like index, which is resulted by the different factors of graphene contents and electric field strength.

Moreover, as shown in Table 3, considering the ratio of thermal conductivity in two perpendicular directions, one parallel and the other perpendicular to the field direction, an optimal processing window related to the graphene contents and the electric field was found. Accordingly, the inventors have investigated the relationships between the anisotropy index or the alignment index and the main processing parameters.

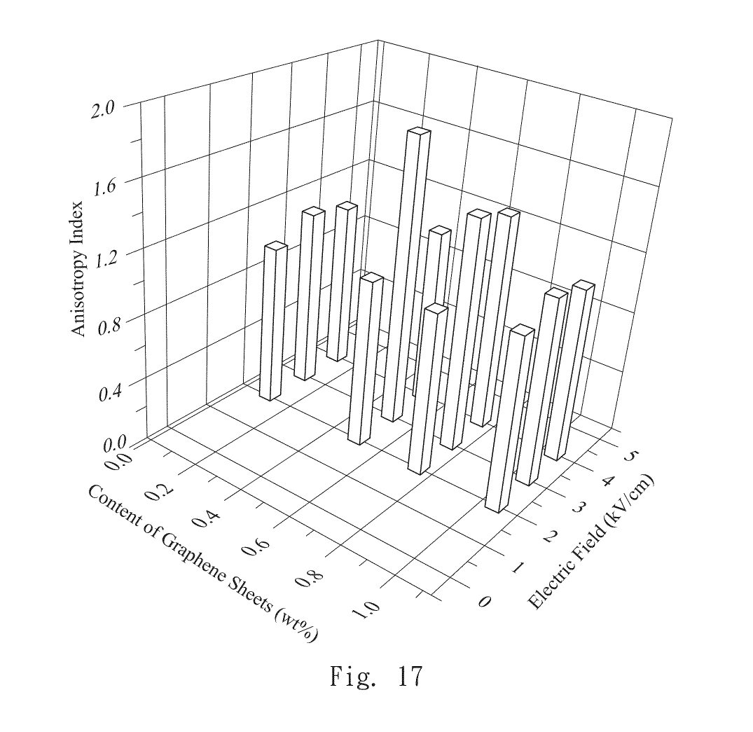

As shown in FIG. 17, a highest peak value of 1.83 (Example 6) of the anisotropy indexes was investigated, when using a graphene content of 0.5 wt % and a electric field strength of 3 kV/cm.

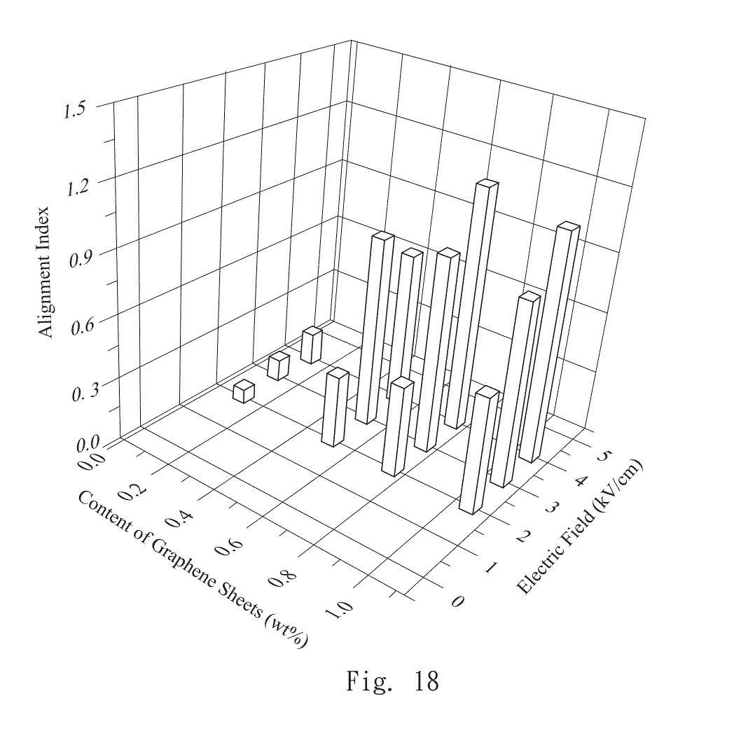

As shown in FIG. 18, a highest peak value of 1.19 (Example 11) of the alignment indexes was investigated, when using a graphene content of 0.75 wt %, and a electric field strength of 4 kV/cm. Thus, the optimal processing window can be found according to the characteristic requirements of the composites.

TABLE 3

| | | | Carbon | | | | | |
|---|---|---|---|---|---|---|---|---|
| | Silicone | | nanotube | Electric | Thermal conductivity | | | |
| | Weight | | Weight | field | (W/mK) | | | |
| | ratio | Viscosity | ratio | strength | X | Z | Anisotropy | Alignment |
| | (wt %) | (cps) | (wt %) | (kV/cm) | direction | direction | index | index |
| Example 1 | 99.9 | 2750 | 0.1 | 2 | 0.35 | 0.34 | 1.02 | 0.07 |
| Example 2 | 99.5 | 3000 | 0.5 | 2 | 0.46 | 0.43 | 1.06 | 0.35 |
| Example 3 | 99.25 | 3500 | 0.75 | 2 | 0.40 | 0.39 | 1.03 | 0.44 |
| Example 4 | 99 | 4000 | 1 | 2 | 0.33 | 0.30 | 1.11 | 0.56 |
| Example 5 | 99.9 | 2750 | 0.1 | 3 | 0.57 | 0.50 | 1.14 | 0.12 |
| Example 6 | 99.5 | 3000 | 0.5 | 3 | 0.77 | 0.42 | 1.83 | 0.92 |
| Example 7 | 99.25 | 3500 | 0.75 | 3 | 0.68 | 0.46 | 1.48 | 0.95 |
| Example 8 | 99 | 4000 | 1 | 3 | 0.64 | 0.54 | 1.19 | 0.89 |
| Example 9 | 99.9 | 2750 | 0.1 | 4 | 0.42 | 0.39 | 1.08 | 0.16 |
| Example 10 | 99.5 | 3000 | 0.5 | 4 | 0.40 | 0.35 | 1.14 | 0.76 |
| Example 11 | 99.25 | 3500 | 0.75 | 4 | 0.52 | 0.37 | 1.39 | 1.19 |
| Example 12 | 99 | 4000 | 1 | 4 | 0.31 | 0.28 | 1.12 | 1.12 |

Although the present disclosure has been described in considerable detail with reference to certain embodiments thereof, other embodiments are possible. Therefore, the spirit and scope of the appended claims should not be limited to the description of the embodiments contained herein.

It will be apparent to those ordinarily skilled in the art that various modifications and variations may be made to the structure of the present disclosure without departing from the scope or spirit of the disclosure. In view of the foregoing, it is intended that the present disclosure cover modifications and variations thereof provided they fall within the scope of the following claims.

What is claimed is:

1. A method for manufacturing an aligned graphene sheets-polymer composite, comprising the steps of:
dispersing a plurality of graphene sheets in a polymer fluid to form a mixture;
applying a field in an acting direction to the mixture for the alignment of the graphene sheets to form a plurality of graphene filament bundles substantially parallel to each other in the polymer fluid, and
solidifying the mixture to form the aligned graphene sheets-polymer composite,
wherein the aligned graphene sheet-polymer composite has an anisotropy index in a range of 1.00 to 2.00, which is the ratio of the thermal conductivity in a direction parallel to the field direction to the thermal conductivity in a direction vertical to the acting direction of the field.

2. The method of claim 1, wherein the graphene sheets have a content of 0.01 to 1.00 wt % based on the total weight of the composite.

3. The method of claim 1, wherein the graphene filament bundles are aligned substantially parallel to the acting direction of the field.

4. The method of claim 1, wherein the field is an electric field, a magnetic field, a mechanical field or an electromagnetic field.

5. The method of claim 1, wherein the step of applying the field to the mixture is applying the electric field to the mixture, and the electric field strength is in a range of 1 to 5 kV/cm.

6. The method of claim 5, wherein the graphene sheets-polymer composite has an alignment index in a range of 0.01 to 1.30, which is calculated by a formula below:
alignment index=content of graphene sheets (wt %)×electric field strength (kV/cm)×(anisotropy index)×1,000/viscosity of the polymer fluid (cps).

7. The method of claim 1, wherein the polymer fluid is selected from the group consisting of silicone rubber, nature rubber, polyurethane and a combination thereof.

8. The method of claim 1, wherein the polymer fluid has a viscosity in a range of 2,500 to 3,500 cps at 25° C.

9. The method of claim 1, wherein the step of applying the field to the mixture to align the graphene sheets to form the grahene filament bundles substantially parallel to each other in the polymer fluid further comprises forming a plurality of interconnected graphene filaments, and at least one of the interconnected graphene filaments is connected to at least two graphene filament bundles.

10. The method of claim 1, wherein each of the graphene sheets has an aspect ratio in a range of 0.01 to 3,000,000.

11. An aligned graphene sheets-polymer composite, comprising:
a polymer matrix; and
a plurality of aligned graphene sheets including a plurality of graphene filament bundles disposed in the polymer matrix, and the graphene filament bundles are substantially parallel to each other.

12. The composite of claim 11, wherein the aligned graphene sheets have a content of 0.01 to 1.00 wt % based on the total weight of the composite.

13. The composite of claim 11, wherein the aligned graphene sheets further comprises a plurality of interconnected graphene filaments, and at least one of the interconnected graphene filaments is connected to at least two graphene filament bundles.

14. The composite of claim 11, wherein each of the graphene filament bundles has a diameter in a range of 1 to 20 μm.

15. The composite of claim 11, wherein a portion of the graphene filament bundles are contacted to each other to form a graphene rod bundles.

16. The composite of claim 15, wherein each of the graphene rod bundles has a maximum width more than or equal to 50 μm.

17. The composite of claim 11, wherein the graphene sheets-polymer composite has an anisotropy index in a range of 1.00 to 2.00, which is the ratio of the thermal conductivity in a direction parallel to the field direction to the thermal conductivity in a direction vertical to the field direction.

18. The composite of claim 17, wherein the graphene sheets-polymer composite has an anisotropy index in a range of 1.30 to 2.00, and the aligned graphene sheets are consisting essentially of the graphene filament bundles and the interconnected graphene filaments.

19. The composite of claim 11, wherein the polymer matrix is selected from the group consisting of silicone rubber, nature rubber, polyurethane and a combination thereof.

20. The composite of claim 11, wherein each of the graphene sheets has an aspect ratio in a range of 0.01 to 3,000,000.
